(19) United States
(12) Patent Application Publication
(10) Pub. No.: US 2011/0172128 A1
(43) Pub. Date: Jul. 14, 2011

(54) MULTI-WELL DEVICE

(76) Inventors: Anthony Davies, Dublin 7 (IE); Dermot Kelleher, County Dublin (IE); Yuri Volkov, Dublin (IE); Siobhan Mitchell, Dublin (IE)

(21) Appl. No.: 13/063,828

(22) PCT Filed: Sep. 14, 2009
(86) PCT No.: PCT/IE2009/000064

§ 371 Date: Mar. 14, 2011

Related U.S. Application Data
(60) Provisional application No. 61/136,541, filed on Sep. 12, 2008.

(51) Int. Cl. C40B 60/00

(52) U.S. Cl. 506/33

(57) ABSTRACT

A device comprising a plurality of sample wells wherein the device has a plurality of compartments, each compartment surrounding at least one well. The compartments are defined by compartment wall means. The compartment wall means may be associated with at least one well or the compartment wall means may be associated with a group of wells. The compartment may house an environmental buffering system.

The invention relates to a device for use in culturing and/or assaying samples such as biological, chemical, physical, biochemical and/or nanotechnical samples and the like.

### INTRODUCTION

All chemical, biological, physiological and physical processes are influenced by environmental elements such as temperature, pH and chemical composition. Uncontrolled changes in any of these factors can exert unwanted physical, chemical and/or biological effects on the specimen/sample in question leading to poor reproducibility or disruption of a given scientific and/or manufacturing process.

With the emergence of high throughput and multiplexed biological, chemical and materials screening, the use of multi-welled assay plates has become standard for almost all automated experimental and storage applications. Conventionally cells and tissue samples are cultured in plates which typically have 96 wells or well formats of 1536-, 384-, 48- or 24-wells. However, many of these experimental procedures comprise multiple steps requiring translocation between several different storage, processing and experimental platforms such as plate shakers, plate readers and the like. Movement of the plate between a variety of locations subject the plate and, more importantly, samples retained in the plate to variations in environment and/or temperature fluctuations. These variations can have a detrimental effect on the samples. Fluctuations in temperature across a multi-well plate is a recognised problem and it has been well documented that standard multi-well plates suffer from an “edge effect” once the plate has been removed from an incubator.

The “edge effect” refers to the periphery of the culture device or multi-well plate which is more exposed than the centre of the culture device and therefore lose heat faster when the device is removed from an incubator. FIG. 1 (prior art) is a schematic illustrating temperature fluctuation across a multi-well plate. The well labelled 501 is on the extremity of the plate and the temperature of this well is lower than the temperature of wells 502 and 503. Well 503 is located in the centre of the plate is one of the warmest wells.

Lundhalt et al., J. Biomol. Screening, 2003 8(5):566-570 have devised a method of reducing the edge effect by incubating newly seeded multi-well plates at room temperature for a period of time prior to placing the plates in a CO₂ incubator.

A further attempt to try and minimise the impact of adverse external effects has included the use of plates which are retained inside a housing type chamber, however this equipment is bulky, cumbersome to use and costly.

There is a clear need for an improved system whereby cells and tissue samples may be grown and cultured with minimal impact from external factors.

### STATEMENTS OF INVENTION

According to the invention there is provided a multi-well device comprising a plurality of sample wells wherein the device has a plurality of compartments, each compartment surrounding at least one well.

The compartment may be defined by compartment wall means. The compartment may be defined by an outer compartment wall means. The compartment wall means may be associated with at least one well. The compartment wall means may be associated with a group of wells. Each well may have an associated compartment wall means. The compartment wall means may surround a well.

The well may be defined by a well wall means and the compartment may be defined between the compartment wall means and the well wall means. The well wall means may be shorter than the compartment wall means.

The compartment wall means may comprise a generally polygonal form.

The compartment wall means may comprise a generally cylindrical form.

The compartments may be the same size. Alternatively, the compartments may be of different sizes.

The compartments may be the same shape. Alternatively, the compartments may be of different shapes.

The multi-well device may comprise a frame and the compartment wall means may extend from the device frame.

The compartment wall means may project above the well.

At least one compartment may comprise a lid. The compartment wall means may contact the lid. The compartment wall means may form an air tight seal with the lid.

The compartment wall means may extend from the lid. The compartment wall means may be integral with the lid. An intermediate wall means may extend from the lid to locate with a well wall means.

The compartment wall means may be formed from a thermally conductive material. The compartment wall means may be formed from a metal such as stainless steel or aluminium.

The compartment wall means may be formed from a substantially non-thermally conducting material. The compartment wall means may be formed from a plastics material such as polystyrene, polypropylene or polythene.

The compartment wall means comprise a dark coloured material.

The invention also provides a device for housing a sample comprising a sample well surrounded by a compartment. The compartment may be defined by a compartment wall means. The compartment wall means may have a generally polyglonal form. The compartment wall means may comprise a generally cylindrical form. The device may comprise a frame and the compartment wall means may extend from the device frame. The device may comprise a lid. The compartment wall means may extend from the lid. The compartment wall means may be integral with the lid. An intermediate wall means may extend from the lid to locate with a well wall means

In accordance with the invention, one or more compartment may house an environmental buffering system. The environmental buffering system may minimise fluctuations in the level of one or more of: moisture, humidity, temperature, and atmospheric gases.

The environmental buffering system may be in a liquid form.

The environmental buffering system may be in a matrix form. The environmental buffering system may be solid or semi-solid at room temperature. The environmental buffering system may comprise a gel-like material. The environmental buffering system may comprise a natural gel-like material. The environmental buffering system may comprise a synthetic gel-like material. The environmental buffering system may comprise a semi-synthetic gel-like material. The gel-like material may be a polymer. The gel-like material may comprise one or more selected from the group consisting of agar, agarose, acrylamide and gelatine. The gel-like material may be aqueous based.

The environmental buffering system may comprise one or more additive selected from the group consisting of oxygen scavengers, exothermic compounds, endothermic compounds, dessicants, pH indicators, dye and anti-microbial agents.

The environmental buffering system may contain a dye. The dye may impart a dark colour to the environmental buffering system.

A plurality of compartments may house the same environmental buffering system. Alternatively, a plurality of compartments may house different environmental buffering systems.

The device may comprise a heating means. The heating means may be an electrical heating means. The heating means may be located in a compartment.

The invention further provides an outer sleeve, collar or receptacle which surrounds an individual well in a multi-well device.

### BRIEF DESCRIPTION OF THE DRAWINGS

The invention will be more clearly understood from the following description of an embodiment thereof, given by way of example only, with reference to the accompanying drawings, in which:

FIG. 1 (Prior art) is a top plan view of a multi-well plate according to the prior art with a lid removed;

FIG. 2 is a top plan view of a multi-well plate in accordance with an embodiment of the invention;

FIG. 3 is a top plan view of a multi-well plate in accordance with an alternative embodiment of the invention;

FIG. 4 is an enlarged top plan view of a single well of the multi-well plate of FIG. 3;

FIG. 5 is an enlarged isometric partially cross sectional view of a single well of the multi-well plate of FIG. 3;

FIG. 6 is a top plan view of a portion of a multi-well plate in accordance with a further embodiment of the invention;

FIG. 7 is an isometric exploded view of a lid in accordance with an embodiment of the invention;

FIG. 8 is an enlarged isometric view of a single compartment of the lid of FIG. 7;

FIG. 9 is an enlarged side view of the single compartment of FIG. 8 in use assembled with the associated well;

FIG. 10 is an enlarged cross-sectional view of a single well in accordance with an embodiment of the invention;

FIG. 11 is a top plan view of a multi-well slide device in accordance with an embodiment of the invention;

FIG. 12 is a partially cross sectional view of a portion of the multi-well slide of FIG. 11;

FIG. 13 is an underneath plan view of a portion of the multi-well slide of FIG. 11;

FIG. 14 is an exploded side view of a portion of the multi-well slide of FIG. 11;

FIG. 15 is an exploded isometric view of wells of a portion of the multi-well slide of FIG. 11; and

FIG. 16 is a top plan view of a multi-well device in accordance with another embodiment of the invention.

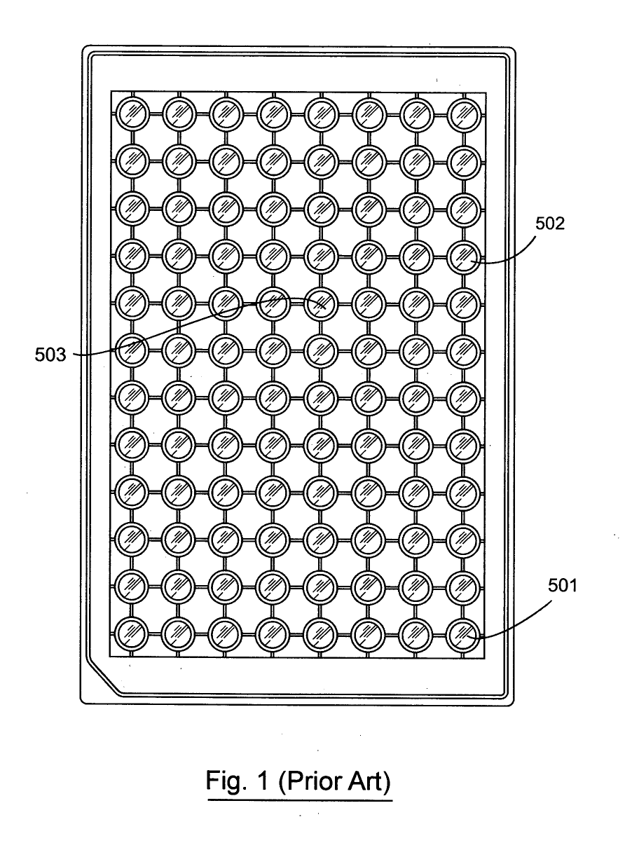

### DETAILED DESCRIPTION

We describe a multi-well plate or device housing an environmental buffering system which reduces moisture loss, unwanted thermal changes and fluctuations in atmospheric gasses (such as CO₂) for plates or devices maintained in a CO₂ incubator or similarly controlled environmental system.

In one embodiment, a well of a multi-well device is surrounded by a collar or sleeve which defines an outer well receptacle or compartment which is used to contain an environmental buffering agent which may take the form of gels, liquids or matrices.

The outer collar or sleeve is defined by a wall which may be constructed from a number of materials depending on the application. For example, the wall may be constructed from a material which is a poor thermal conductor and a good insulator such as polystyrene, polypropylene or polythene which may reduce the loss of thermal energy from a sample well. Alternatively, the outer wall may be constructed from a thermal conductor material such as a metal for example stainless steel or aluminium which will facilitate the heat uptake of a sample well when the device is placed into a controlled environment such as a tissue culture incubator.

The cross sectional area, chemical make up, mass and volume of the environmental buffering material is important for determining the environmental effects exerted by a device in accordance with the invention. A significant feature is that the collar or sleeve can differ in terms of its dimensions (such as cross sectional area), and/or material (for example materials differing in their thermal conductive properties such as metals and plastics) which allows for a fine tuning of the environmental buffering effects across a multi-well device.

The invention provides a device that allows for the fine tuning of environmental buffering resulting in optimisation and vastly reduced environmental gradient effects (such as thermal and atmospheric gradients) across a multi-well device. The device described herein is optimised for environmental buffering as well as improved or more rapid environmental restoration when external environmental fluctuations have been restored.

In one aspect we describe a multi-well device such as a 96-well plate incorporating sleeves or receptacles or compartments which may contain an environmental buffering agent. In one embodiment, the cross sectional area of sleeve or compartment differs depending on the position of the well in a multi-well device: the compartments at the outer corners of the device may have a large cross sectional area as these wells are subject to the most extreme environmental changes, the next largest are the compartments surrounding the outer wells at the sides of the device which are also vulnerable to environmental fluctuations. This configuration of compartments will offer optimal environmental buffering with improved re-warming characteristics. For example thermal and environmental gradients are reduced to a minimum.

We also describe an outer sleeve, collar or receptacle which surrounds individual wells in a multi well device. The collar, sleeve or receptacle may define a compartment for housing a range of materials and/ or agents such as gels, liquids, powders and solids. The physical characteristics of the compartments and the device may differ in cross sectional area, height, wall thickness, material from which it is constructed for example plastic or metal. The contents of the compartment, receptacle or sleeve may be coloured to alter the thermal absorption characterises of the material i.e. darker colours absorb and radiate heat better than lighter colours. Various embodiments of the invention may be combined in one device to allow for example for different environmental conditions in portions of a device and/or in individual wells. In accordance with an embodiment of the invention, the environmental buffering material is held in close proximity to an individual well. One significant advantage of this is that if one environmental buffering sleeve or compartment fails only one well is lost. This is in contrast to configurations where outer regions of a plate or interstitial spaces are filled with a buffering agent. The collar, sleeve or receptacle may be incorporated as an integral part of the multi-well device or inserted into the device individually or collectively for example as part of a lid. The contents of the sleeve, collar or receptacle may extend above the upper level of the inner (sample) well to form a seal with the lid of the plate, for example to prevent diffusion of harmful vapours such as formaldehyde from cell fixation agents (e.g. 4-8% v/v).

The sleeve, collar or receptacle may contain a heating element or similar electrical component for maintained warming during experiments when the device is removed from controlled environment (CO₂ incubator). In one arrangement, the sleeve, collar or receptacle may extend from a lid to surround a sample well when the lid is placed on a multi-well device. In this configuration, the sleeve does not fully meet with the bottom of the plate leaving an air gap for free diffusion of gasses

Some aspects of the invention will now be described in more detail.

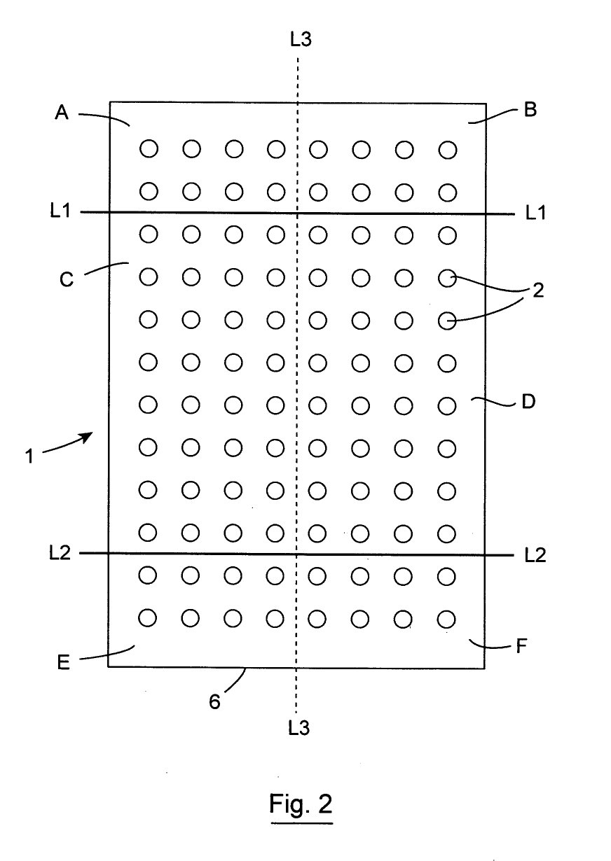

Referring to FIG. 2, a multi-well plate 1 of the invention comprises a plurality of sample wells 2 and a plurality of compartments A, B, C, D, E, F defined by compartment wall means indicated by lines L1-L1, L2-L2 and L3-L3. In the illustrative embodiment shown in FIG. 2, six compartments A, B, C, D, E, F are shown and each compartment A, B, C, D, E, F surrounds a group of wells. A multi-well plate 1 may be formed with compartments A, B, C, D, E, F in different locations to those illustrated in FIG. 2. The positioning of the compartments A, B, C, D, E, F may be custom designed depending on experimental requirements. The multi-well plate may contain more or fewer compartments than the six compartments A, B, C, D, E, F illustrated in FIG. 2. The compartments A, B, C, D, E, F may have the same size or have different sizes. The compartments A, B, C, D, E, F are defined by compartment wall means L1-L1, L2-L2 and L3-L3. In FIG. 2, the compartment wall means L1-L1, L2-L2 and L3-L3 are substantially linear however the compartment wall means may have a generally polyglonal or cylindrical form. The compartments A, B, C, D, E, F may have the same shape or one or more of the compartments A, B, C, D, E, F may have a different shape.

The compartment wall means L1-L1, L2-L2 and L3-L3 may be formed from a thermally conductive material such as a metal for example stainless steel or aluminium. Alternatively, the compartment wall means L1-L1, L2-L2 and L3-L3 may be formed from a substantially non-thermally conducting material for example a plastics material. Suitable plastic materials include polystyrene, polypropylene, polythene and the like. The compartment wall means L1-L1, L2-L2 and L3-L3 may be formed from a material having a dark colour as darker colours absorb and radiate heat more efficiently than lighter colours. The compartment wall means L1-L1, L2-L2 and L3-L3 may be formed from the same or different materials. The multi-well plate 1 comprises a frame 6, the compartment wall means L1-L1, L2-L2 and L3-L3 may extend from the frame. One or more of the compartments may comprise a lid. The lid may be moveable to allow access to the sample well.

One or more of the compartments A, B, C, D, E, F may house an environmental buffering system. In one aspect, the environmental buffering system may be considered as an onboard buffering system. In use, the environmental buffering system may provide for atmospheric (such as humidity and/or gaseous buffering) and/or thermal buffering of a sample housed in the device.

Preferable attributes of the environmental buffering system may include, but are not limited to: capable of maintaining and/or modifying and/or absorbing and/or dissipating and/or generating and/or releasing thermal energy, atmospheric gasses (such as CO₂ O₂, N₂ and the like) and solvent vapours such as water, DMSO and organic compounds and the like.

The environmental buffering system may be in the form of a liquid, such as a viscous liquid, or have a semi-solid or substantially solid form. The environmental buffering system may be substantially solid at the temperature range of the experimental activity to be carried out. For example the environmental buffering system may be solid or semi-solid at room temperature. The environmental buffering system may have gel like properties such that the system can absorb shocks. For example, the system may buffer a sample housed in the device from external vibrations by absorbing and/or dissipating mechanical shocks.

The environmental buffering system may be in the form of a polymerisable matrix or gel, for example a porous matrix or gel.

The environmental buffering system may be prepared as a liquid solution that solidifies (polymerises) over time. Suitable polymers for use in making the environmental buffering system include agarose and/or acrylamide and/or gelatine and/or agar and the like. The polymer(s) may be dissolved in a solution or solvent such as an aqueous solution or solvent. The polymer(s) may be dissolved in water.

Typically, the weight/volume (w/v) percentage concentration of an agarose matrix solution is from about 0.1% to about 10%, or from about 0.1% to about 5%, such as from about 0.1% to about 2.5%. Typically, the polymer solution may be made at a concentration of about 1%. It will be appreciated that the concentration of polymer used depends on the consistency of the matrix required. The skilled person will appreciate that the environmental temperature of the room in which the matrix solution is made will affect the consistency of the polymerised matrix. For example, at higher temperatures, a higher percentage matrix solution will be required to ensure complete polymerisation of the matrix solution. The environmental buffering system may retain a polymerised (set or solid or semi-solid) state at the temperature at which the system is to be employed in the final use.

The end use temperature of the environmental buffering system may have an impact on the concentration percentage of polymer in the system. Preferably a system with the lowest possible percentage concentration of polymer will be used. The lower the concentration of the polymer in the system the higher the concentration of solution/solvent in the system. Likewise, the higher the concentration of polymer in the system; the lower the concentration of solution/solvent in the system (inverse relationship of polymer concentration to solution/solvent concentration). Systems containing a lower percentage of polymer for example 0.1-2% polymer may contain more moisture systems with a higher percentage of polymer, for example 8-10% polymer. For certain experimental activities such as tissue culture, it is desirable that the system contains as much moisture as possible as moisture can sacrificially evaporate from the system rather than the sample in non-humid conditions. Desirably, the system may also allow the donation and/or maintenance and/or saturation and/or removal of moisture from the device.

A large range of compounds may be added to the environmental buffering system for example prior to polymerisation of matrix/gel based systems. For example additives may be added to the system to allow for maximal retention of CO₂ such that CO₂ is released slowly. Anti-oxidants and oxygen free radical and scavenges may also be added to the system.

Examples of additives that can be included in the system are:
Oxygen scavengers

Examples of oxygen scavengers include but are not limited to the following: sulphite, catalase, carnosine, N-acetylcarnosine, homocarnosine, carbohydrazide, oxygen scavenging enzymes, and pyrogalol.
Compounds that produce an exothermic reaction such as compounds that give out heat.

Examples of compounds that produce an exothermic reaction include but are not limited to the following: sodium hydroxide and hydrochloric acid; glycine (glycerol) and lower polyglycols. Desirably, the reactions may be suppressed and/or activated by the end user for example by alteration of environmental conditions.
Compounds that produce an endothermic reaction such as compounds that absorb heat.

Examples of compounds that produce an endothermic reaction include but are not limited to the following: sodium hydroxide and water; citric acid and sodium hydroxide. Desirably, the reactions may be suppressed and/or activated by the end user, for example by altering environmental conditions surrounding the matrix
CO₂ maintainers/stabilisers

for example, bicarbonate of soda/scavengers, for example, soda lime.
Desiccants

Examples of desiccants include but are not limited to the following: silica gel, cobalt chloride.
pH indicators

for example phenol red.
Dyes

Examples of dyes include but are not limited to the following: fungal dye indicators such as Remazol Brilliant Blue R (RBBR), poly R-478, guaiacol and tannic acid. Dyes may be added to the substance for use in immunofluorescence or fluorescence applications. For example, a dye may be used to minimise the exposure of a fluorescent sample to light, thereby reducing the fading effect of the fluorescence and prolonging the storage period of a fluorescent sample. Dyes that will impart a dark colour on the environmental buffering system may also be added to alter the thermal adsorption characteristics of the system as darker colours absorb and radiate heat more efficiently than lighter colours. Therefore by adding a dark coloured dye to the environmental buffering system, the dissipation and/or absorption of heat by the environmental buffering system can be controlled. Furthermore, if a dark coloured dye is added to the environmental buffering system, when the environmental buffering system is in situ in a multi-well device, the dark colour will limit or reduce the amount of light accessing a sample well. In this manner, an optically transparent multi-well device can be converted into a black walled multi-well device by simply adding a dark coloured dye to the environmental buffering system.
Infection indicator

For example, an early warning system for bacterial contamination.
Antimicrobial agents

Examples of antimicrobial agents include but are not limited to the following: bacteriordals, antibiotics, fungicidals, chemical inhibitors of microbial growth and the like.

The system may also contain a combination of additives for example the system may contain a carbon source (such as glucose, lactose, sucrose or the like) and a pH sensitive colour indicator (such as phenol red) to indicate microbial metabolic activity in the substance. Alternatively, the system may contain citric acid and bromothymol blue such that a colour change reaction from blue to green would occur if the system became more alkaline due to microbial activity.

Once the environmental buffering system has been made, the buffering system may be dispensed, in its liquid form, into one or more of the compartments and if appropriate, the system may be allowed to polymerise.

Multi-well devices housing an environmental buffering system may be stored until required. For example, the devices may be sealed in polyethylene film or the like and stored at +4° C. until required. If the environmental buffering system includes an antimicrobial agent, the device may have a longer shelf-life compared to a device in which the environmental buffering system does not contain an antimicrobial agent.

In use, a multi-well device housing an environmental buffering system may reduce fluctuations in external factors that could impact on the growth and culturing of cell and/or tissue samples. The environmental buffering system may maintain a substantial even temperature across a compartment for example, when a multi-well device is transferred from a 37° C. incubator to a laboratory bench. Alternatively, or in addition, the environmental buffering system may minimise moisture loss and/or fluctuations in the concentration of atmospheric gases (such as CO₂) as the buffering system may act as a sacrificial donor of moisture or atmospheric gases so that the level of moisture and/or atmospheric gases of a sample housed within a sample well remain relatively constant for the duration of an experiment.

One or more of compartments A, B, C, D, E, F may house the same or a different environmental buffering system. For example the compartments A, B, C, D, E, F may be arranged in bands and each compartment A, B, C, D, E, F may house a different environmental buffering substance.

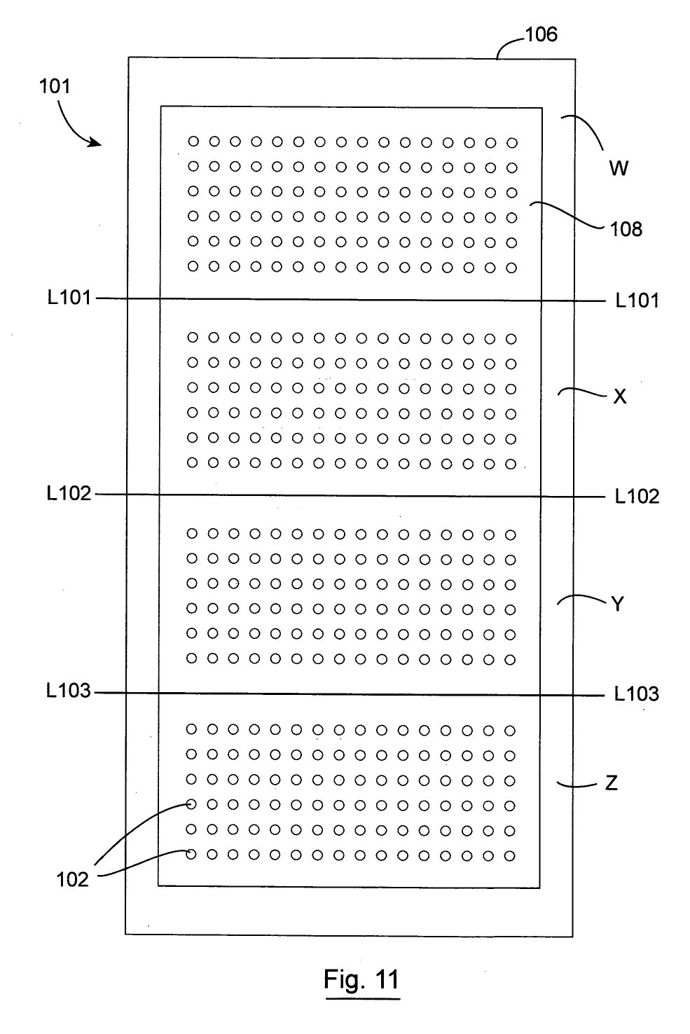

Referring to FIGS. 11 to 15, an alternative embodiment of the invention is shown. The multi-well device 101 comprises a substrate 107. The substrate 107 may be optically transparent, for example the substrate 107 may be a glass microscope slide. In the embodiment of FIG. 11, the substrate 107 has been subdivided into compartments W, X, Y, Z. Compartments W, X, Y, Z are defined by compartment wall means L101-L101, L102-L102, L103-L103. In the embodiment shown the substrate 107 has been subdivided into four compartments W, X, Y, Z and the compartments W, X, Y, Z are of substantially the same size. It will be appreciated that the substrate may be subdivided into more than four or less that four compartments and that each compartment could be a different size. The multi-well device comprises a perimeter wall 106. One or more of the compartments W, X, Y, Z comprises a plurality of sample wells 102. In the embodiment of FIG. 11, each of the compartments W, X, Y, Z comprises ninety six sample wells 102, in this case the multi-well device 101 can be considered to be a 384-well device. The number of sample wells 102 present in each compartment W, X, Y, Z may vary depending on the end use of the multi-well device. For example compartment W may comprise ninety six sample wells 102, compartment X may comprise forty eight sample wells 102, compartment Y may contain twenty four sample wells 102, and compartment Z may contain zero sample wells 102.

The sample wells 102 may be substantially cylindrical in shape and hold a nanolitre volume of liquid. For example in the embodiment of FIG. 11 in which each compartment W, X, Y, Z comprises ninety six sample wells 102, each sample well has the capacity to hold about 50 nl of liquid. Advantageously, the multi-well device 101 configuration described herein is reagent sparing as only very small (nl) volumes of reagent are required per sample well 102 compared to the volumes used in a conventional 96-well plate assay format. The sample wells 102 are defined by side walls, the side walls may be constructed from a polymeric material such as a plastics material. The sample wells 102 may be arranged on a matrix which can be adhered to the substrate 107 for example through a pressure sensitive adhesive to form a water tight seal between the side walls defining the sample wells 102 and the substrate 107. One or more of the compartments W, X, Y, Z may house an environmental buffering system 108. The environmental buffering system 108 may be considered to be an on-board buffering system. The environmental buffering system 108 may substantially surround the sample wells 102. The environmental buffering system 108 is preferably a gel based system that is solid or semi-solid at room temperature. Suitable environmental buffering systems are described in detail above. Each compartment W, X, Y, Z may house the same or different environmental buffering systems.

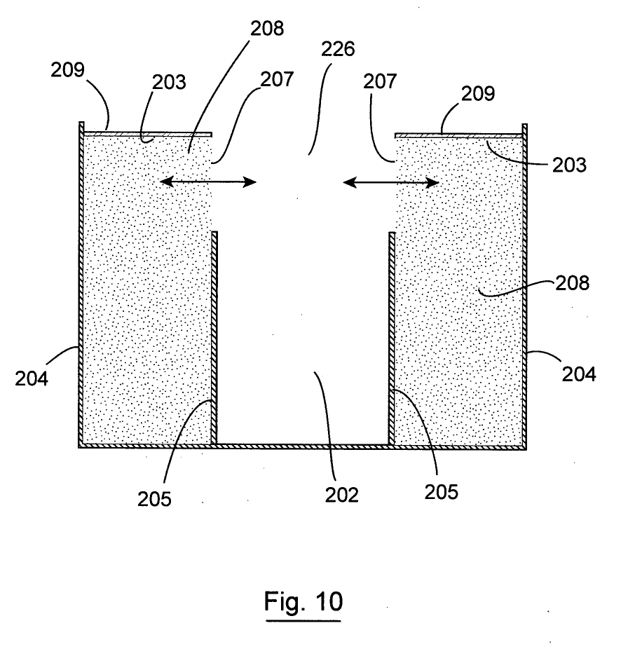

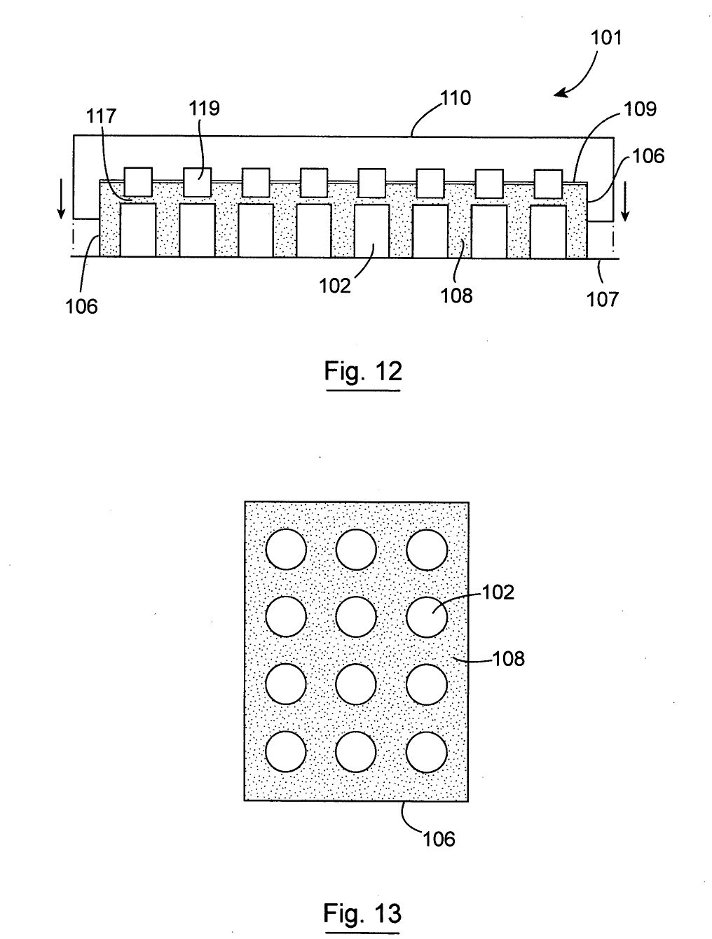

Referring to FIG. 12, the multi-well device 101 may comprise a removeable lid 110. The lid 110 may be configured to prevent the access of microbes into the sample wells 102. The multi-well device comprises an environmental buffering system 108 located between and around the sample wells 102. The multi-well device 101 comprises side wall portions 106 to retain the environmental buffering system 108. The environmental buffering system 108 may project above the height of the sample well 102 such that a gap 117 is formed between the sample well and the environmental buffering system which may allow for targeted buffering of the sample well 102 (this is described in more detail in relation to FIG. 10 below). The multi-well device 101 may comprise a sheet or film 109 layered on top of the environmental buffering system 108. The sheet or film 109 may be water and/or gas impermeable or semi-permeable. A water and/or gas impermeable sheet may prevent the exchange of moisture and/or environmental gasses such as carbon dioxide and oxygen, whereas a water and/or gas semi-permeable sheet or film may permit the exchange of moisture and/or atmospheric gasses such as carbon dioxide and oxygen. In one embodiment the sheet or film 109 may be formed from a polymeric material such as a plastics material for example cellophane. In the embodiment of FIG. 12, the sheet or film 109 is interspersed with members 119. The sheet or film 109 and members 119 may be provided as a sub-assembly. The members 119 are configured to be held above the opening of the sample wells 102 when the sheet or film 109 and members 119 are in situ. The placement of the members 119 is such that it allows for the transfer of moisture and gases between the environmental buffering system 108 and sample wells 102, but it reduces the area of free space between the opening of the sample well 102 and the lid 110 thereby reducing the level of condensation formed in the multi-well device 101.

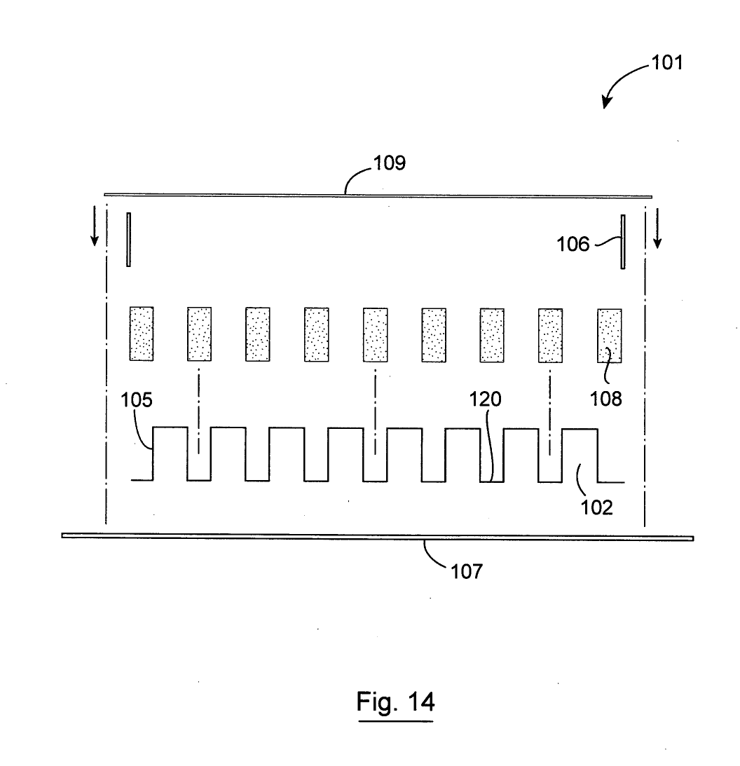

Referring to FIG. 14, the multi-well device 101 may comprise detachable sample wells 102. The sample wells 102 may be formed as a matrix or interconnected strip of discrete sample wells 102. Each sample well 102 comprises a side wall 105 defining the sample well 102. Two or more sample wells 102 may be interconnected by a strip or layer 120 extending between the side walls 105 of adjacent sample wells 102.

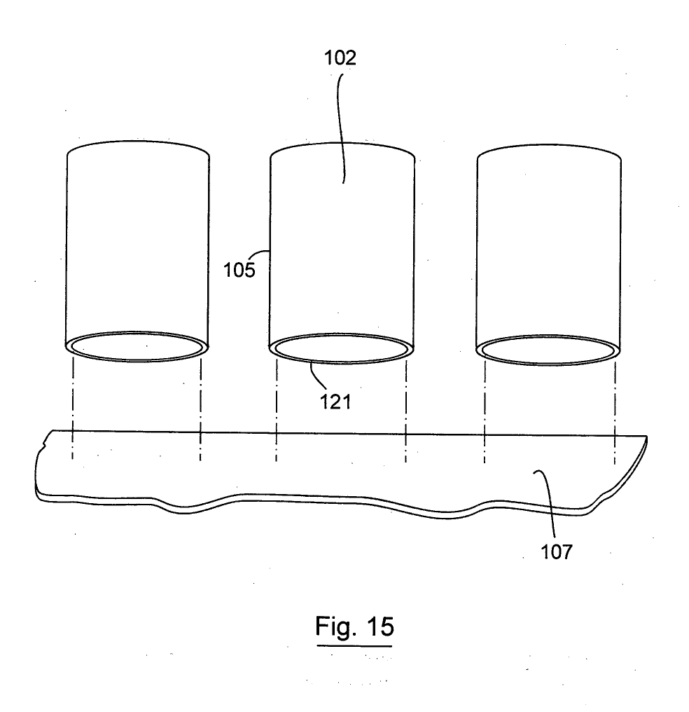

Referring to FIG. 15, three sample wells 102 are shown. The sample well 102 comprises a layer of adhesive 121 for attaching the sample well 102 to the substrate 107. In one embodiment, the layer of adhesive 121 may extend to the strip or layer 120 extending between adjacent sample wells 102. The adhesive 121 may be a pressure sensitive adhesive. When the sample well 102 is adhered to the substrate 107, a substantially water tight seal is formed between the sample well 102 and the substrate 107 so that liquid housed in a sample well 102 is retained by the sample well 102 and does not egress from the sample well 102. The environmental buffering system 108 may comprise a layer of polymerised gel or gel-like material. In situ the polymerised gel or gel-like material substantially surrounds the sample wells 102, in this manner, the polymerised gel or gel-like material forms a layer containing a plurality of orifices that correspond in size and number to the sample wells 102.

In the embodiment of FIG. 14, the multi-well device 101 comprises a water impermeable or semi-permeable sheet or film 109 that covers the environmental buffering system 108 and extends across the opening of the sample wells 102. Following completion of an assay or an experiment, the multi-well device may be disassembled by removing the sheet or layer 109, the environmental buffering system 108, the perimeter side wall 106, compartment wall means L101-L101, L102-L102, L103-L103 and the sample wells 102 from the substrate 107. The substrate 107 which may be a glass microscope slide can then be processed simply without the need to process each sample well 102 individually for example samples on the slide can be fixed and if necessary stained using conventional techniques. The sheet or film 109 and environmental buffering system 108 may be formed as a sub assembly.

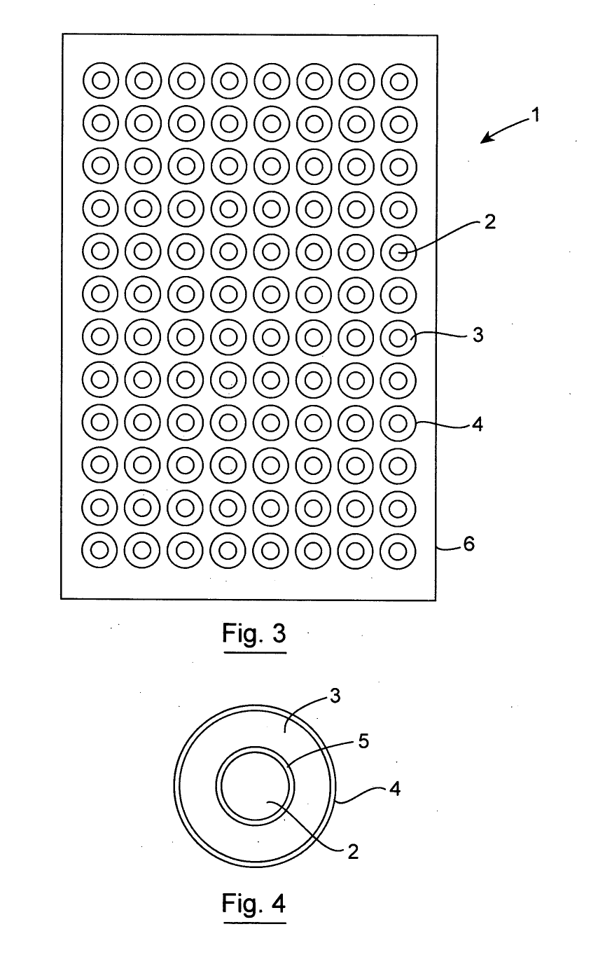

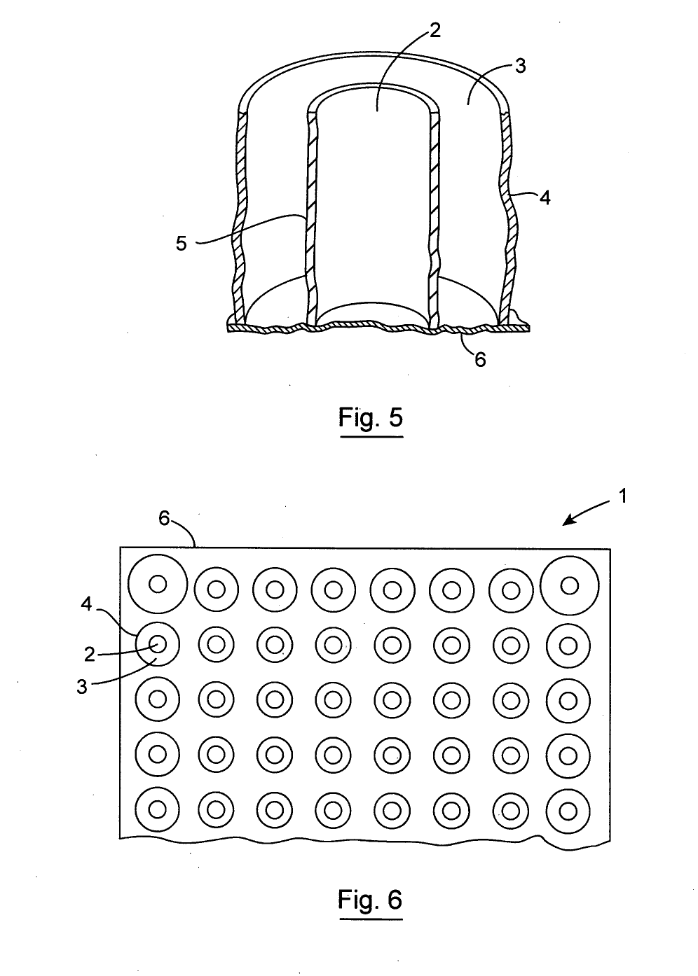

Referring to FIG. 3, in one embodiment each sample well 2 of a multi-well plate 1 comprises an individual compartment 3 defined by a compartment wall means 4. In the illustrative embodiment of FIG. 3 the compartment wall means 4 are substantially cylindrical in shape so that the distance between the side wall 5 defining a well 2 and the compartment wall means 4 is substantially the same across the circumference of a well 2 (FIG. 4). In this respect, the compartment wall means 4 can be considered as a sleeve surrounding a well 2. Alternatively, the compartment wall means 4 may have a generally polyglonal form. The shape of the compartments 3 may be the same or different throughout the multi-well plate 1. Referring to FIG. 3, the multi-well plate comprises a frame 6. As can be seen most clearly from the enlarged view of FIG. 5, the compartment wall means 4 may extend from the plate fame 6.

In the embodiment of FIG. 5, the compartment wall means 4 are substantially the same height as the sample well 2. In an alternative arrangement, the compartment wall means 4 may project above the sample well 2. In the embodiment of FIG. 3, the compartments 3 are substantially the same size, however referring for example to FIG. 6, an alternative arrangement is shown in which the compartments 3 have different sizes. In the embodiment of FIG. 6, compartments 3 surrounding wells 2 at the corners of the plate frame 6 are the largest compartments and compartments 3 surrounding wells 2 at the periphery of the plate frame 6 are larger than compartments 3 surrounding wells 2 located towards the middle of the plate 1. This arrangement of compartments 3 may reduce the “edge effect” associated with wells 2 located at the periphery of a plate 1 and may ensure that there is a substantially uniform temperature across all the wells 2 of a plate 1 such that all the wells 2 of a plate 1 have substantially the same rate of warming and cooling.

The multi-well plate 1 may comprise a lid. In the embodiment in which the compartment wall means 4 project above the sample well 2, the compartment wall means 4 may contact the underside of the lid of the multi-well plate. The underside of the lid of a multi-well plate and the top of the compartment wall means 4 may form a seal for example a substantially air tight seal. When a seal is formed, an individual well 2 can be considered to be substantially isolated from the other sample wells 2 of a multi-well plate 1. Isolating individual wells 2 of a multi-well plate 1 may prevent diffusion of gaseous vapours from chemicals such as formaldehyde from individual wells 2 to other wells 2 of a plate 1, this configuration may be useful in time point experiments where it is necessary to fix cells (for example with about 4% to about 8% v/v formaldehyde) in individual wells at different time points as the formaldehyde vapours may be prevented from diffusing into wells containing living cells.

One or more of compartments 3 may house an environmental buffering system as described above. The environmental buffering system may be the same or different within one or more of the compartments 3.

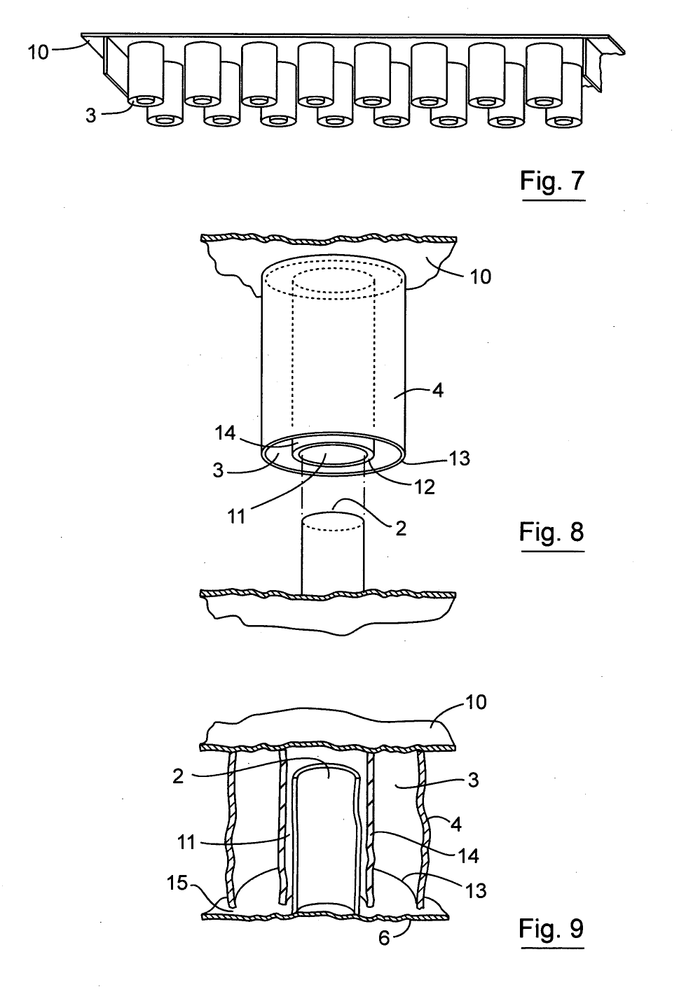

Referring to FIG. 7, an alternative arrangement of compartments 3 are shown to extend from a lid 10 configured to fit a multi-well plate. As can be seen more clearly from FIG. 8, the compartments 3 comprise two compartment wall means 4, 14. Compartment wall means 4 defines the outer boundary wall of the compartment 3 whereas compartment wall means 14 defines an inner space 11 of suitable dimensions to accommodate a well 2 of a multi-well plate. The compartment 3 has a closed end formed by the underside of lid 10 and an open end 12 defined by compartment wall means 14. An environmental buffering system as described above can be housed in compartment 3. The open end 13 of compartment 3 may be covered with a substantially porous material so that the environmental buffering system is securely retained within compartment 3 while permitting the diffusion of gases and moisture from the environmental buffering system. In the configuration of FIG. 8, a gel-type environmental buffering system is used. In use, when the lid 10 is placed on a multi-well plate, a well 2 of a multi-well plate is accommodated within space 11 (FIG. 9) a head space is formed within space 11 and there is a gap 15 around the base of a well 2 which allows for diffusion of gasses within the multi-well plate.

Referring to FIG. 10, a single sample well 202 is shown. In this embodiment, the sample well 202 comprises side walls 205 defining the sample well 202. Side walls 204 define a compartment 203 between the side walls 205 defining the sample well 202 and side walls 204. The side walls 204 defining the compartment 203 project above the height of the side walls 205 defining the sample well 202 so that a gap 207 is formed between the sample well 202 and the compartment 203. An environmental buffering system 208 such as an environmental buffering system described in detail above may be housed in the compartment 203. In the configuration of FIG. 10, the environmental buffering system 208 is solid or semi-solid at room temperature. For example the environmental buffering system 208 may in the form of a polymerised gel. In this case the environmental buffering system 208 has sufficient physical properties to maintain its shape within the compartment 203 so that the environmental buffering system 208 does not extend into the sample well 202 through gap 207. The environmental buffering system 208 is covered with a sheet or film 209. The sheet or film 209 may be water and/or gas impermeable or semi permeable. A water and/or gas impermeable sheet or film may prevent the exchange or moisture and/or atmospheric gasses such as carbon dioxide and oxygen, whereas a water and/or gas semi permeable sheet or film may permit the exchange of moisture and/or atmospheric gasses such as carbon dioxide and oxygen. In one embodiment, the sheet or film 209 may be formed from a polymeric material such as a plastics material for example cellophane or a gas permeable layer that would permit or prevent the exchange of atmospheric gasses such as CO₂ and oxygen. The sheet or film 209 may act to seal the environmental buffering system 208 in compartment 203. The sheet or film 209 may extend across the opening 226 of the sample well 202. When the sheet or film 209 is in situ, environmental buffering may be targeted to the sample well 202 as atmospheric and gaseous exchange will take place in the direction of the arrows to/from the environmental buffering system 208 into/from the sample well 102 through the gap 107. The gap 207 between the sample well 202 and the compartment 203 acts as a conduit for atmospheric and gaseous buffering of a sample housed in the sample well 202. The sheet or film 209 and the environmental buffering system 208 may be formed as a sub-assembly.

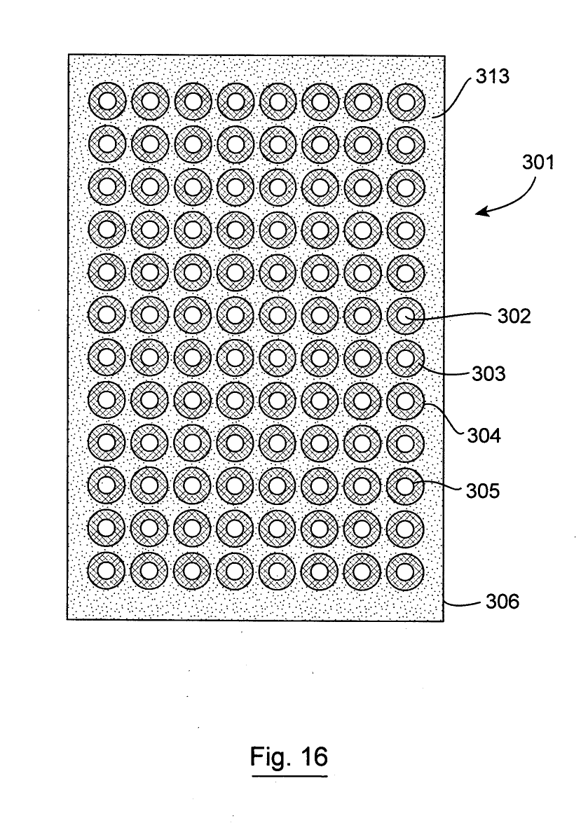

Referring to the embodiment of FIG. 16, the multi-well device 301 comprises a plurality of sample wells 302. Each sample well 302 is substantially surrounded by a compartment 303. The compartment 303 is formed between the side walls 305 defining the sample well 302 and the side walls 304 defining the compartment 303. The multi-well device 301 comprises a perimeter wall 306. A compartment 313 is formed between the perimeter wall 306 of the multi-well device 301 and the side walls 304 defining the compartments 303. Compartment 303 may house an environmental buffering system such as an environmental buffering system described in detail above. When compartment 313 houses an environmental buffering system, the environmental buffering system may substantially surround compartments 303. The environmental buffering system housed in compartments 303 may be different to the environmental buffering system housed in compartment 313. For example, compartments 303, which is in close proximity to the sample well 302, may house a moisture buffering system whereas compartment 313 may house a thermal buffering system. The multi-well device 301 may be a multi-well plate or a multi-well microscope slide.

Whilst the invention has been described above with reference to multi-well devices such as multi-well plates and multi-well microscope slides, it will be appreciated that the compartment-well arrangement can also be configured for single well devices.

The invention is not limited to the embodiment hereinbefore described, with reference to the accompanying drawings, which may be varied in construction and detail.

1-58. (canceled)

59. A multi-well device comprising a plurality of sample wells wherein the device has a plurality of compartments, each compartment surrounding at least one well.

60. The multi-well device as claimed in claim 59 wherein the compartments are defined by compartment wall means, the compartment may be defined by an outer compartment wall means.

61. The multi-well device as claimed in claim 60 wherein a compartment wall means is associated with at least one well, or a compartment wall means is associated with a group of wells.

62. The multi-well device as claimed in claim 60 wherein each well has an associated compartment wall means, the compartment wall means may surround a well.

63. The multi-well device as claimed in claim 60 wherein the well is defined by a well wall means and the compartment is defined between the compartment wall means and the well wall means, the well wall means may be shorter than the compartment wall means.

64. The multi-well device as claimed in claim 60 wherein the compartment wall means comprises a generally polygonal form, or a generally cylindrical form.

65. The multi-well device as claimed in claim 59 wherein the compartments are the same size, or the compartments are of different sizes.

66. The multi-well device as claimed in claim 59 wherein the compartments are the same shape, or the compartments are of different shapes.

67. The multi-well device as claimed in claim 60 wherein the multi-well device comprises a frame and the compartment wall means extend from the device frame, the compartment wall means may project above the well.

68. The multi-well device as claimed in claim 59 wherein at least one compartment comprises a lid, the compartment wall means may contact the lid, the compartment wall means may form an air tight seal with the lid, the compartment wall means may extend from the lid, for example the compartment wall means may be integral with the lid, an intermediate wall means may extend from the lid to locate with a well wall means.

69. The multi-well device as claimed in claim 60 wherein the compartment wall means are formed from a thermally conductive material, the compartment wall means may be formed from a metal such as stainless steel or aluminium.

70. The multi-well device as claimed in claim 60 wherein the compartment wall means are formed from a substantially non-thermally conducting material, the compartment wall means may be formed from a plastics material such as polystyrene, polypropylene or polythene.

71. The multi-well device as claimed in claim 60 wherein the compartment wall means comprise a dark coloured material.

72. A device for housing a sample comprising a sample well surrounded by a compartment.

73. The device as claimed in claim 72 wherein the compartment is defined by a compartment wall means, the compartment wall means may have a generally polyglonal form, or a generally cylindrical form.

74. The device as claimed in claim 73 wherein device comprises a frame and the compartment wall means extend from the device frame.

75. The device as claimed in claim 73 comprising a lid, the compartment wall means may extend from the lid, the compartment wall means may be integral with the lid, an intermediate wall means may extend from the lid to locate with a well wall means.

76. The device as claimed in claim 59 wherein one or more compartment houses an environmental buffering system.

77. The device as claimed in claim 76 wherein the environmental buffering system minimises fluctuations in the level of one or more of: moisture, humidity, temperature, and atmospheric gases.

78. The device as claimed in claim 76 wherein the environmental buffering system is in a liquid form.

79. The device as claimed in claim 76 wherein the environmental buffering system is in a matrix form, the environmental buffering system may be solid or semi-solid at room temperature, the environmental buffering system may comprise a gel-like material such as a natural gel-like material or a synthetic gel-like material, or a semi-synthetic gel-like material.

80. The device as claimed in claim 79 wherein the gel-like material is a polymer, the gel-like material may comprise one or more selected from the group consisting of agar, agarose, acrylamide and gelatine, the gel-like material may be aqueous based.

81. The device as claimed in claim 76 wherein the environmental buffering system comprises one or more additive selected from the group consisting of oxygen scavengers, exothermic compounds, endothermic compounds, dessicants, pH indicators, dye and anti-microbial agents, the environmental buffering system may contain a dye, the dye may impart a dark colour to the environmental buffering system.

82. The device as claimed in claim 76 wherein a plurality of compartments house the same environmental buffering system.

83. The device as claimed in claim 76 wherein a plurality of compartments house different environmental buffering systems.

84. The device as claimed in claim 59 comprising a heating means, the heating means may be an electrical heating means, the heating means may be located in a compartment.

85. An outer sleeve, collar or receptacle which surrounds an individual well in a multi-well device.
